(19) United States
(12) Patent Application Publication
(10) Pub. No.: US 2002/0015418 A1
(43) Pub. Date: Feb. 7, 2002

(54) Integrated messaging system

(75) Inventor: Shinichiro Uemura, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/911,697

(22) Filed: Jul. 25, 2001

(30) Foreign Application Priority Data
Jul. 25, 2000 (JP) 2000-229057

(51) Int. Cl. H04J 3/16; H04J 3/22

(52) U.S. Cl. 370/466; 370/352; 370/356

(57) ABSTRACT

An integrated messaging system is characterized in that: a media conversion port packetizes a message from a circuit switching network through which a subscriber's calling signal is sent; an IP store and reproduction port converts the packetized message into a voice file; a mail conversion port converts the voice file into an e-mail attachment-file form; and an e-mail server stores the message. Further, in the integrated messaging system: the IP store and reproduction port converts a message from a packet switching network, through which another subscriber's calling signal is sent, into the voice file; the mail conversion port converts the voice file into the e-mail attachment-file form; and the e-mail server stores the message. Consequently, an integrated messaging system can be realized with a simple structure wherein multimedia messages are stored in one place, and thus managed easily.

### BACKGROUND OF THE INVENTION

The present invention relates to an integrated messaging system, and in particular, to an integrated messaging system which stores and reproduces multimedia messages (for example, voice, animation, texts and so on) in a circuit switching network or a packet switching network on a PC (personal computer) through a telecommunication line such as the Internet.

### DESCRIPTION OF THE RELATED ART

FIG. 1 is a block diagram showing a structural outline of a control method of “a voice storage reproduction system” which is disclosed in Japanese Patent Application Laid-Open No. HEI 9-298596.

FIG. 2 is a flowchart showing an example of a procedure in the case of a voice store service in a service control device which is also disclosed in the above application. In the following, the operation of “the voice storage reproduction system” described above will be explained using FIGS. 1 and 2.

After a service control device 108 receives a calling signal from a subscriber 106 (step S101), the service control device 108 analyzes the requested service from the subscriber (step S102), chooses an appropriate circuit selection device 102 and a voice guidance device 103, and directs the circuit selection device 102 to make a path between a switching device 101 and the voice guidance device 103 (step S103).

The circuit selection device 102, which has received the direction to connect up, connects the subscriber 106 to the voice guidance device 103. After the circuit from the subscriber 106 to the voice guidance device 103 is connected, the control device 108 directs the voice guidance device 103 to send voice guidance to the subscriber 106 (Step S104).

After the subscriber 106 listens to the voice guidance such as service information from the voice guidance device 103, he/she chooses additional services according to the voice guidance. The service control device 108 analyzes the additional services chosen by the subscriber 106 (step S105), and executes the chosen scenarios of the services (step S106).

In the case where the chosen service is a voice store service, the service control device 108 directs the voice guidance device 103 and a voice storage device 105 to store the subscriber's voice in the voice storage device 105 (step S1061).

After the subscriber 106 finishes the voice store service, the service control device 108 directs to release the circuit selection device 102, the voice guidance device 103, the voice storage device 105, and the circuit used for the service (step S1062).

FIG. 3 is a block diagram showing a structure and an operation of “a voice storage reproduction service device” which is disclosed in Japanese patent No. 2828029. In FIG. 3, in the case where a subscriber 203 takes a voice storage reproduction service, an incoming signal is sent to a control port 207 through a control line 700 by a telephone/switching device network 202.

According to the incoming signal, the control port 207 recognizes which voice processing port 204-1 and which circuit in it receive the call from the subscriber terminates. Besides, according to the subscriber's number, the control port 207 searches a storage processing port 205-1 in which the subscriber's voice is stored. Then a voice storage reproduction service is executed by using a direction to the speech processing port 204-1. In executing this service, the voice processing port 204-1 executes storage/reproduction operation to the storage processing port 205-1 through ATM-SW206 (Arrows Y1 and Y2).

In the case where a subscriber executes reproduction, deletion, and store of voice to a storage processing port 205-2 of another subscriber using the service, a voice processing port 204-2 executes store/reproduction operation of data to another storage processing port 205-2 through ATM-SW206 as well as operation of a usual service. Thereby, the subscriber can store/reproduce voice data using another storage processing port (Arrows Y3 and Y4).

FIG. 4 is a block diagram showing a structure of a conventional voice storage reproduction system in the case where a plurality of voice storing ports are provided. Usually, a plurality of voice storing ports 301 are provided because of the number of service subscribers and the capacity of the port. The following is an example showing that a voice storing port is provided each in Tokyo and Osaka.

In this structure, a message, which is for a telephone answering machine, for a service subscriber 302-1 in Tokyo is always stored in a voice storing port 301-1 in Tokyo. In other words, when a service subscriber 302-2 in Osaka calls the service subscriber 302-1 in Tokyo and lefts a message for him/her, the message is stored in the voice storing port 301-1 in Tokyo, not in a voice storing port 301-2 in Osaka. In the following, the operation will be explained.

First, a system control port 303 detects the call origination from Osaka. The system control port 303 interrogates an HLR 304, and recognizes that the phone of the called subscriber in Tokyo is turned off or out of service area. Then the call from Osaka is connected to the voice storing port 301-1 in Tokyo and an operation for storing the message is executed.

Second, the call from Osaka is connected to Tokyo from a circuit switching network 305-2 through a transit network 306. A voice processing port 307-1 in Tokyo converts the voice into voice data for storing. The voice storing port 301-1 in Tokyo stores the converted voice data.

However, the conventional voice storage reproduction system described above involves the following drawbacks.

First, in the case where the system is constructed so that a user can reproduce the message in the telephone answering machine on a PC through the Internet, the system becomes very complex. This is because it is necessary to convert the message stored in the voice storing port into an e-mail form by a converter, and transfer it to a mailbox on the Internet for storing it. By executing these operations, the message in the telephone answering machine exists in two places; in the voice storing port and the mailbox. Therefore, the management becomes complicated.

Second, the conventional voice storage reproduction system can not be flexibly expanded according to increase of traffic. The reason is that there is a limit to the unit of the port for expansion because of its structure in which the circuit selection device and the voice guidance device are physically connected fixedly by hardware (HW).

Third, in the conventional voice storage reproduction system, circuit cost for relay to the voice storing port gets high. This problem occurs since hardware (HW) is employed for the transit network which connects the circuit switching network(s) and the voice storing port(s) of each area.

### SUMMARY OF THE INVENTION

It is therefore a first object of the present invention to provide an integrated messaging system which is not complex but simple in the structure, wherein a user can store and reproduce a message on a PC through the Internet, and also a message can be easily managed by integrating and storing messages in one place.

A second object of the present invention is to provide an integrated messaging system in which high durability for trouble and high availability can be realized, as well as conversion ports can be flexibly added according to traffic.

A third object of the present invention is to provide an integrated messaging system in which relay between a circuit switching network and a voice storing device can be executed at lower circuit cost.

According to a first aspect of the present invention, for achieving the objects mentioned above, there is provided an integrated messaging system for storing and reproducing a message from a subscriber comprising:

a circuit switching network;

a media conversion port which receives the message from the subscriber through the circuit switching network and packetizes the message;

a conversion port which converts the packetized message into a storing form; and

a storing port which stores the message converted into the storing form.

According to a second aspect of the present invention, there is provided an integrated messaging system for storing and reproducing a message from a subscriber comprising:

a circuit switching network;

a packet switching network;

a media conversion port which receives the message from the subscriber through the circuit switching network and packetizes the message;

a conversion port which converts the packetized message from the media conversion port and the packet switching network into a storing form; and

a storing port which stores the message converted into the storing form.

According to a third aspect of the present invention, there is provided an integrated messaging system for storing and reproducing a message from a subscriber comprising:

a circuit switching network;

a packet switching network;

a media conversion port which receives the message from the subscriber through the circuit switching network and packetizes the message;

a conversion port which converts the packetized message from the media conversion port and the packet switching network into an e-mail attachment-file form; and

a storing port which is an e-mail server that stores the message converted into the e-mail attachment-file form.

According to a fourth aspect of the present invention, there is provided an integrated messaging system for storing and reproducing a message from a subscriber who reproduces the message stored in the store ports on a PC through the Internet, comprising:

a circuit switching network;

a packet switching network;

a media conversion port which receives the message from the subscriber through the circuit switching network and packetizes the message;

a conversion port which converts the packetized message from the media conversion port and the packet switching network into an e-mail attachment-file form; and

a storing port which is an e-mail server that stores the message converted into the e-mail attachment-file form, and connected to the Internet.

According to a fifth aspect of the present invention, in one of the first to fourth aspects, the message is a multimedia message at least one selected form voice, a text data, and a moving picture.

According to a sixth aspect of the present invention, in one of the first to fourth aspects, the message is for a telephone answering machine, which is stored in the case where the called subscriber does not answer a phone.

According to a seventh aspect of the present invention, in the third or fourth aspect, the integrated messaging system comprises a data base which relates the subscriber's telephone number to the subscriber's e-mail address and stores the telephone number and the e-mail address.

According to an eighth aspect of the present invention, in one of the first to fourth aspects, the integrated messaging system comprises a data base which relates the subscriber's telephone number to the subscriber's e-mail address and stores the telephone number and the e-mail address, wherein the message is a multimedia message at least one selected form voice, a text data, and a moving picture.

According to a ninth aspect of the present invention, in one of the first to fourth aspects, the integrated messaging system comprises a data base which relates the subscriber's telephone number to the subscriber's e-mail address and stores the telephone number and the e-mail address, wherein the message is for a telephone answering machine, which is stored in the case where the called subscriber does not answer a phone.

According to a tenth aspect of the present invention, in the third or fourth aspect, the integrated messaging system comprises:

a data base which relates the subscriber's telephone number to the subscriber's e-mail address and stores the telephone number and the e-mail address; and

a system control port which controls each port in the system and is connected to the circuit switching network by a common channel line, wherein the media conversion port is connected to the circuit switching network by NNI interface.

According to an eleventh aspect of the present invention, in one of the first to fourth aspects, the integrated messaging system comprises:

a data base which relates the subscriber's telephone number to the subscriber's e-mail address and stores the telephone number and the e-mail address; and

a system control port which controls each port in the system and is connected to the circuit switching network by a common channel line, wherein:

the message is a multimedia message at least one selected form voice, a text data, and a moving picture; and

the media conversion port is connected to the circuit switching network by NNI interface.

According to a twelfth aspect of the present invention, in one of the first to fourth aspects, the integrated messaging system comprises:

a data base which relates the subscriber's telephone number to the subscriber's e-mail address and stores the telephone number and the e-mail address; and

a system control port which controls each port in the system and is connected to the circuit switching network by a common channel line, wherein:

the message is for a telephone answering machine, which is stored in the case where the called subscriber does not answer a phone; and

the media conversion port is connected to the circuit switching network by NNI interface.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of a control system of a conventional voice storage reproduction system;

FIG. 2 is a flowchart showing an operation of a control system of a conventional voice storage reproduction system;

FIG. 3 is a block diagram showing an operation of a conventional voice storage reproduction service device;

FIG. 4 is a diagram showing a structure of a conventional voice storage reproduction system in the case where a plurality of voice storing ports are employed;

FIG. 5 is a block diagram showing a structure of an integrated messaging system according to an embodiment of the present invention;

FIG. 6 is a flowchart showing an operation of an integrated messaging system when it stores a message for a telephone answering machine according to an embodiment of the present invention;

FIG. 7 is a flowchart showing an operation of an integrated messaging system when it reproduces a message for a telephone answering machine according to an embodiment of the present invention;

FIG. 8 is a block diagram showing a part of a structure of an integrated messaging system according to an embodiment of the present invention; and

FIG. 9 is a block diagram showing a structure of an integrated messaging system according to another embodiment of the present invention.

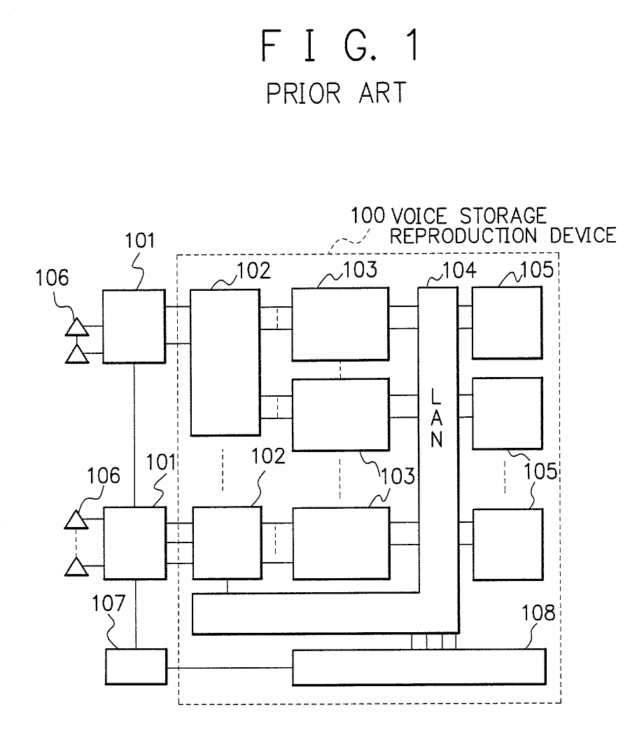

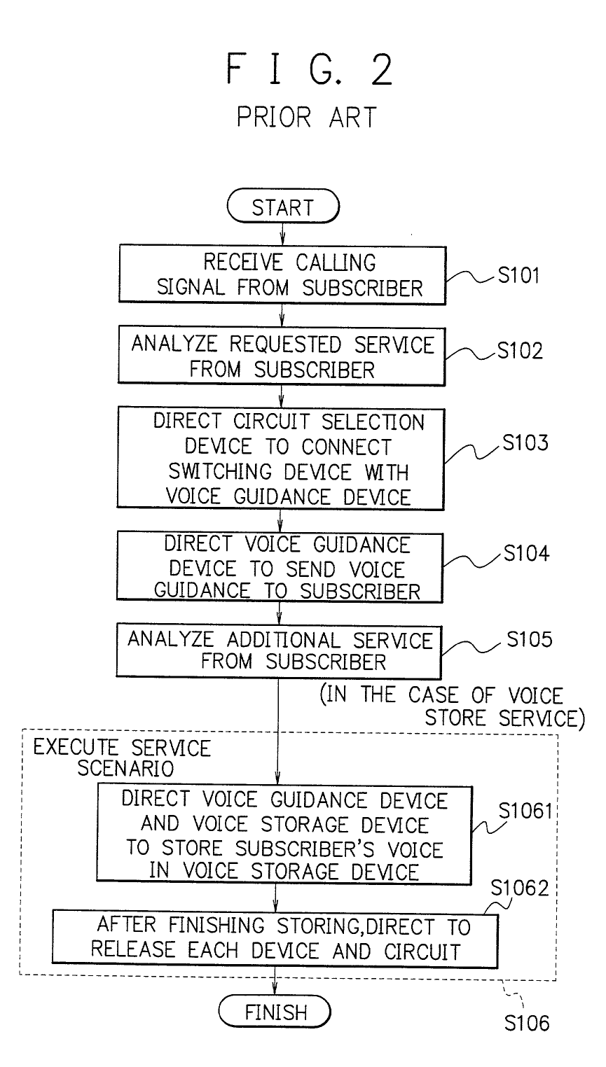

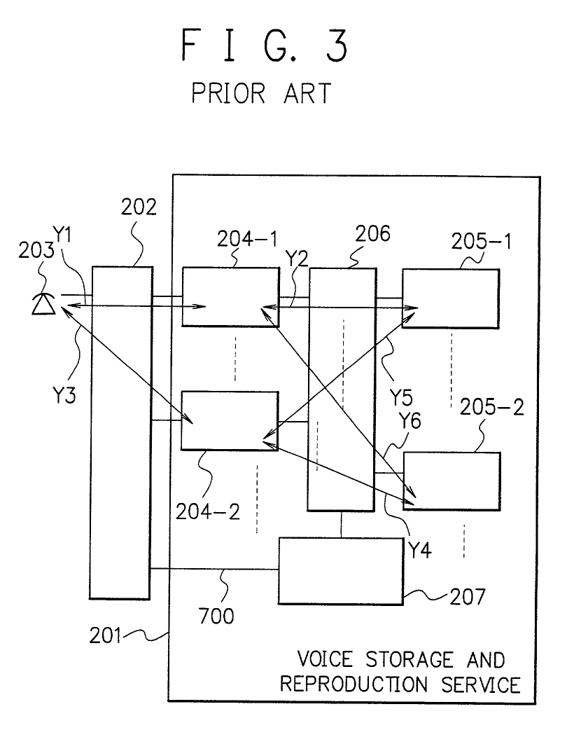

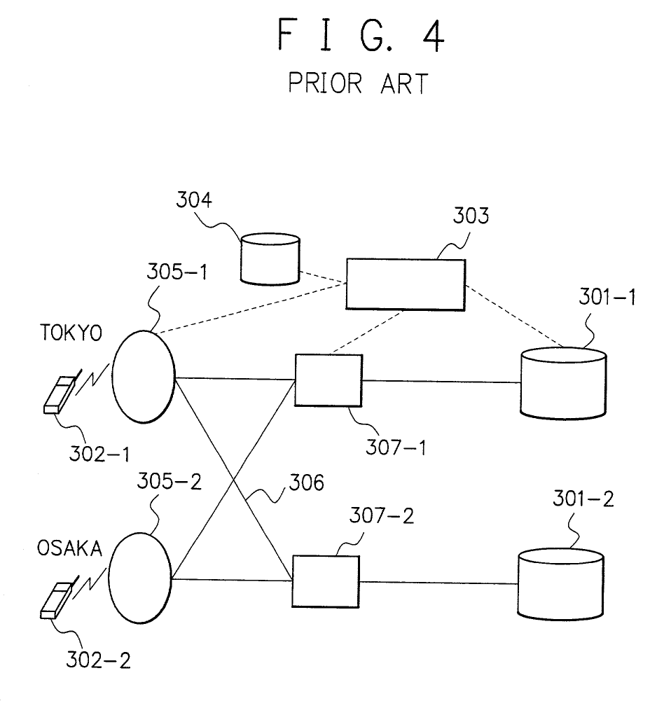

### DESCRIPTION OF THE PREFERRED EMBODIMENTS

Referring now to the drawings, embodiments of the present invention will be explained in detail.

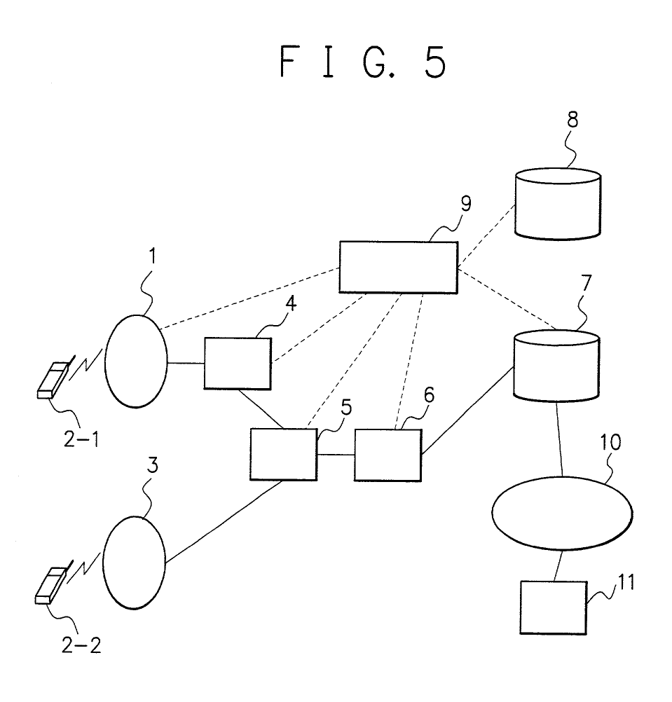

FIG. 5 is a schematic diagram showing a system structure of an integrated messaging system according to an embodiment of the present invention. In FIG. 5, the integrated messaging system comprises: a circuit switching network 1; a subscriber 2-1 whose calling signal is sent through the circuit switching network 1; a packet network 3; a subscriber 2-2 whose calling signal is sent through the packet network 3; a media conversion port 4 which converts voice from the circuit switching network 1 into VOIP (Voice Over Internet Protocol: packeted voice information); an IP store and reproduction port 5 which converts the VOIP sent from the circuit switching network I through the media conversion port 4 and the VOIP sent from the packet network 3 into a voice file compressed by a voice coding system; a mail conversion port 6 which converts the voice file from the IP store and reproduction port 5 into an e-mail attachment-file form; an e-mail server 7 which stores a message, e-mail, and an absence guidance of subscriber's own voice in each subscriber's mailbox; a data base 8 which relates a subscriber's telephone number to his/her e-mail address and stores them; a system control port 9 which controls each port through a channel line; the Internet 10 which is connected to the e-mail server 7; and a PC 11 which is connected to the Internet 10.

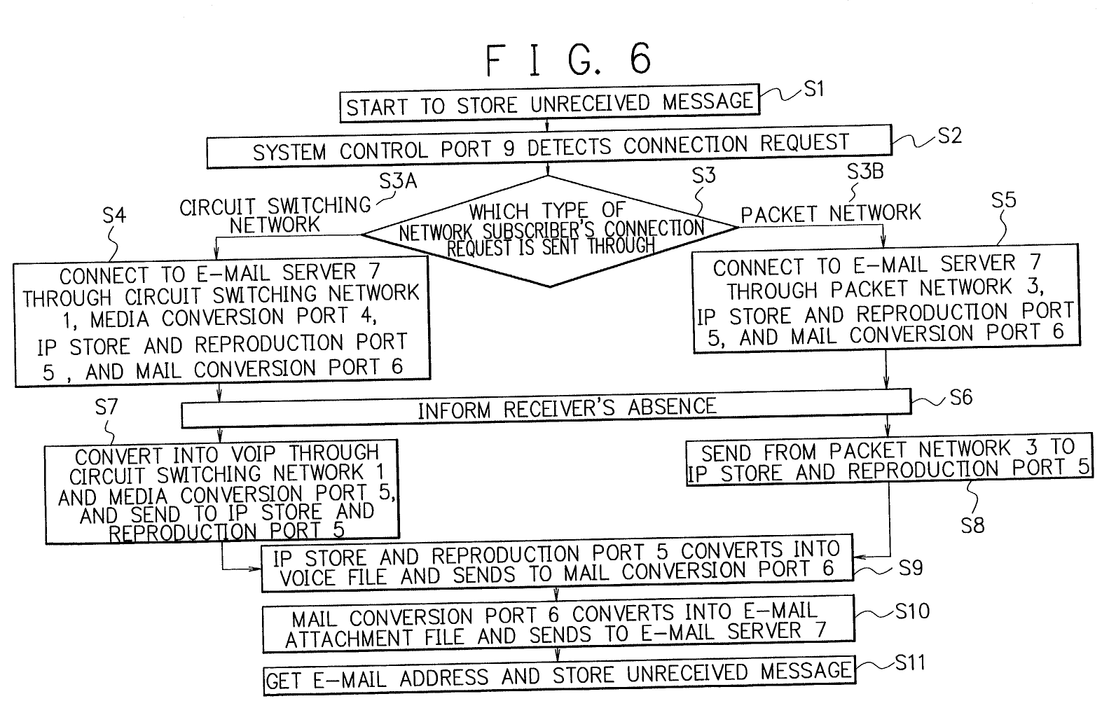

FIG. 6 is a flowchart showing an example of an operation of the integrated messaging system when a message for a telephone answering machine (an unreceived message) is stored according to the embodiment of the present invention. In FIG. 6, in the case when a subscriber in a destination side (referred to as a called subscriber hereinafter) cannot answer the phone for a reason that the power of his/her telephone is turned off or out of service area, an operation to store a message from an calling subscriber starts (Step S1).

The system control port 9 detects a connection request from the calling subscriber through a channel line (Step S2).

Besides, the system control port 9 judges a network type through which the subscriber's calling signal is sent and controls allocating processes (Step S3).

In Step S3, in the case when a calling subscriber is the subscriber 2-1 whose calling signal is sent through a circuit switching network (Step S3A), the system control port 9 controls the circuit switching network 1, the media conversion port 4, the IP store and reproduction port 5, and a mail conversion port 6. Besides, the system control port 9 connects the connection request from the calling subscriber to the e-mail server 7 (Step S4).

In Step S3, in the case when a calling subscriber is the a subscriber 2-2 whose calling signal is sent through a packet network (Step S3B), the system control port 9 controls the packet network 3, the IP store and reproduction port 5, and the mail conversion port 6. Besides, the system control port 9 connects the connection request from the calling subscriber to the e-mail server 7 (Step S5).

The e-mail server 7 reproduces an absence guidance recorded by the called subscriber beforehand and informs the calling subscriber that the called subscriber cannot answer the phone for certain reasons (Step S6). The e-mail server 7 stores the unreceived message for a telephone answering machine.

The message from the calling subscriber 2-1, whose calling signal is sent through the circuit switching network, is inputted to the media conversion port 4 through the circuit switching network 1. After that, the media conversion port 4 converts the inputted voice message into a VOIP, and sends the VOIP to the IP store and reproduction port 5 (Step S7).

The message from the calling subscriber 2-2, whose calling signal is sent through the packet switching network, is sent to the IP store and reproduction port 6 through the packet network 3 (Step S8).

The IP store and reproduction port 5 converts the VOIP voice message from the media conversion port 4 or the packet network 3 into a voice file, and sends the voice file to the mail conversion port 6 (Step S9).

The mail conversion port 6 converts the voice file from the IP store and reproduction port 5 into an e-mail attachment-file form, and transfers it to the e-mail server 7. The e-mail server 7 stores the message of the e-mail attachment-file form (Step S10). In this case, it is necessary that the e-mail server 7 recognizes an e-mail address of the called subscriber, to whom the message is to be stored.

The e-mail server 7 interrogates the data base 8 through the system control port 9, and detects the called subscriber's e-mail address on the e-mail server 7 based on his/her telephone number. After that, the e-mail server 7 stores the massage from the calling subscriber on the e-mail address (Step S11).

A user of the PC 11 can retrieve the message, which is converted into an e-mail attachment-file form and stored as described above, by accessing the e-mail server 7 through the Internet 10.

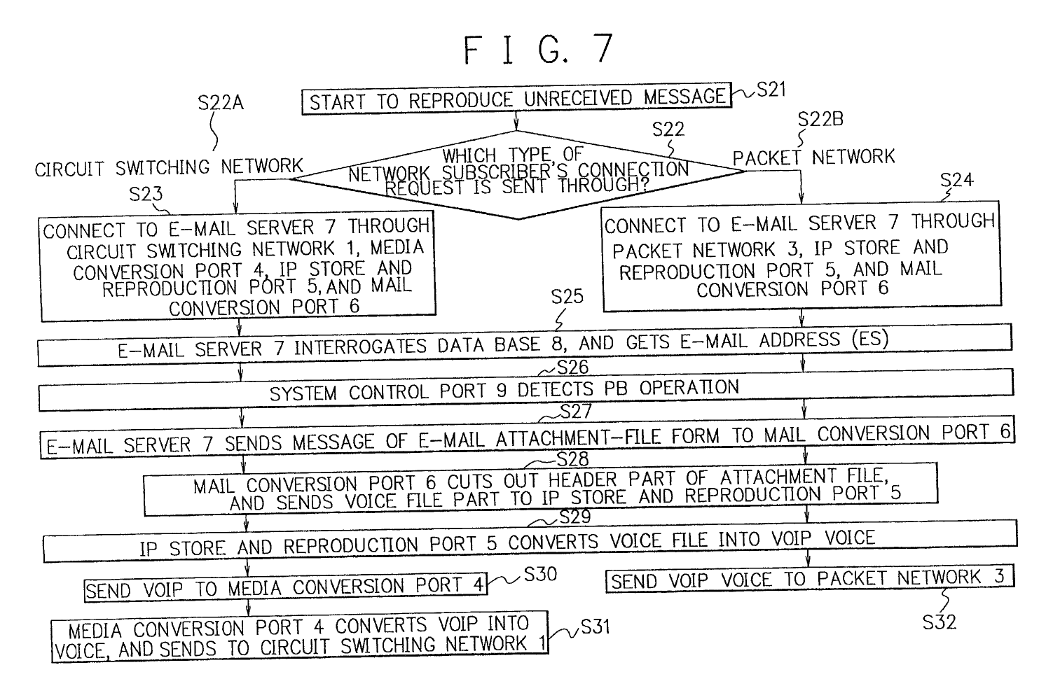

FIG. 7 is a flowchart showing an example of an operation of the integrated messaging system when a message for a telephone answering machine is reproduced according to the embodiment of the present invention. In FIG. 7, an operation for reproducing the message stored in the e-mail box in the e-mail server 7 starts by a subscriber dialing a special service code and so on (Step S22).

The system control port 9 judges a network type through which a subscriber's calling signal is sent and controls allocating processes (Step S22).

In Step S22, a call connection request from the subscriber 2-1, who retrieves a message and whose calling signal is sent through the circuit switching network (Step S22A), is connected to the e-mail server 7 through the circuit switching network 1, the media conversion port 4, the IP store and reproduction port 5, and the mail conversion port 6 (Step S23).

In Step S22, a call connection request from the subscriber 2-2, who retrieves a message and whose calling signal is sent through the packet network (Step S22B) is connected to the e-mail server 7 through the packet network 3, the IP store and the reproduction port 5, and the mail conversion port 6 (Step S24).

In this case, the e-mail server 7 interrogates the data base 8. Thereby the e-mail server 7 recognizes the subscriber's e-mail address on the e-mail server 7 based on his/her telephone number. (Step S25).

The subscriber operates PB (push buttons) in order to hi reproduce the message which is stored in the e-mail address described above. The system control port 9 detects a PB signal from the subscriber who requires reproduction of the message (Step S26). Then the system control port 9 controls each port to reproduce the message.

The e-mail server 7 retrieves the e-mail attachment-file form message stored in the e-mail address of the calling subscriber, and sends the message to the mail conversion port 6 (Step S27).

The mail conversion port 6 cuts out a header part from the e-mail attachment-file form message and sends a voice file part to the IP store and reproduction port 5 (Step S28). The IP store and reproduction port 5 converts the voice file into a VOIP voice (Step S29).

In the case where the subscriber tries to reproduce the message through the circuit switching network 1, the IP store and reproduction port 5 sends the VOIP voice to the media conversion port 4 (Step S30). The media conversion port 4 converts the VOIP voice into a voice for a circuit switching and sends it to the circuit switching network (Step S31).

In the case where the subscriber tries to reproduce the message through the packet network 3, the IP store and reproduction port 5 sends the VOIP voice to the packet network 3 (Step S32). According to these operations, it is possible to reproduce the message.

And also, according to the structure, a user may access to the e-mail server 7 through the Internet 10 from the PC 11, and reproduce the stored message by the operation as described above.

Besides it is possible to record a guidance voice in subscriber's natural voice by almost the same operations to store a message. This means that a subscriber can record an absence guidance in his/her natural voice to encourage a calling subscriber to leave a message.

In the above case, by the subscriber dialing a special service code and so forth, an operation of recording guidance in subscriber's natural voice starts. Then the system control port 9 detects the special service code and connects the call from the subscriber to the e-mail server 7. When the e-mail server 7 interrogates the data base 8 about an e-mail address where the message is to be stored, a search for the address is performed according to the telephone number of the subscriber who records guidance (in the case of storing the message as described hereinbefore, the e-mail server 7 interrogates the address of the called subscriber). The e-mail server 7 stores guidance in the subscriber's natural voice in his/her e-mail address which is received from the data base 8. Also the user may store the guidance from the PC 11 by accessing the e-mail server 7 through the internet 10.

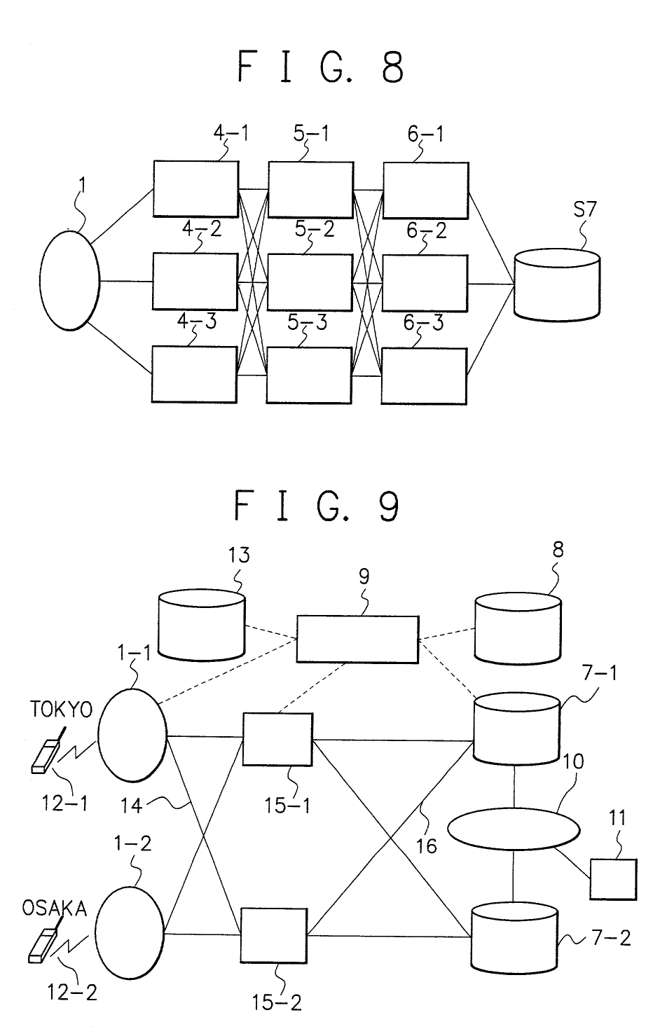

FIG. 8 is a block diagram showing a structure in the case where the conversion ports (the media conversion port 4, the IP store and the reproduction port 5, and the mail conversion ports 6) are expanded according to an increase in traffic.

According to the present invention, the media conversion port 4 terminates a circuit switching, converts a voice into VOIP, and converts a connection with the IP store and reproduction port 5 into IP. By converting into IP, even if expansion or contraction of the ports happens, a connection between each of the ports is easily set up. Therefore, as shown in FIG. 8, it is possible to expand each conversion port according to the traffic. And also connections between the expanded media conversion ports 4-1 to 4-3 and the IP store and reproduction ports 5-1 to 5-3 as well as between the expanded IP store and reproduction ports 5-1 to 5-3 and the mail conversion ports 6-1 to 6-3 can be easily mesh-connected (loop-connected).

Besides, by the above structure, even if one of the media conversion ports 4-1 to 4-3 (for example, a media conversion port 4-1) is shut-downed, one of the IP store and reproduction ports 5-1 to 5-3 (for example, an IP store and reproduction port 5-1) corresponding to the shut-downed media conversion port 4-1 can be used through the other media conversion port 4-1 or 4-2 (for example, a media conversion port 4-2). Therefore, high fault tolerance and high availability can be realized. Also in the case where one of the IP store and reproduction ports 5-1 to 5-3 or one of the mail conversion ports 6-1 to 6-3 is shut-downed, the same high fault tolerance and high availability can be realized.

FIG. 9 is a block diagram showing a structure of an integrated messaging system in the case where a plurality of e-mail servers are equipped according to another embodiment of the present invention.

Usually, more than one e-mail servers 7 are equipped according to the number of service subscribers and the capacity. The FIG. 9 shows an example in the case where an e-mail server 7-1 is equipped in Tokyo, and another e-mail server 7-2 is in Osaka.

In this structure, a message for a service subscriber 12-1 in Tokyo is always stored in the e-mail server 7-1 in Tokyo. That is, when a service subscriber 12-2 in Osaka leaves the message to the service subscriber 12-1 in Tokyo, the message is stored in the e-mail server 7-1 in Tokyo, not in the e-mail server 7-2 in Osaka. The following is an example of the operation.

First, the system control port 9 detects a call from Osaka. The system control port 9 interrogates HLR (Home Location Register) 13, and recognizes that the power of called subscriber's telephone is turned off or out of service area. Then the call from Osaka is connected to the e-mail server 7-1 in Tokyo and an operation of storing the message is executed.

The call from Osaka is connected to the conversion port 15-2 in Osaka, where the voice is converted into an IP voice and into an e-mail attachment-file form, instead of being connected to Tokyo from a circuit switching network 1-2 through a transit network 14. The IP message is stored in the e-mail server in Tokyo through an IP network 16. An inexpensive IP network is employed for the transit of the message from Osaka to Tokyo. What is important here is that the message is relayed through an IP network. Therefore, it does not matter which format is used in the transit. That is, the voice can be transmitted after it is converted into IP voice, after it is compressed by a voice coding system, or after it is converted into an e-mail attachment-file form.

The above embodiments are preferred embodiments of the present invention. Each embodiment can be changed or modified without departing from the scope and spirit of the present invention. For example in the above embodiments of the present invention, the mail conversion port 6 sends an attachment-file form message to the e-mail server 7. However, it is also possible to change an interface of the mail conversion port 6 according to an interface of a storing port which is equipped in the place of the e-mail server 7.

In the above embodiments of the present invention, it is possible to apply the e-mail server 7 to a system in which not only the voice message but also multimedia messages such as voice, images, texts, and faxes are also available.

In the above embodiments of the present invention, the e-mail server 7 stores a message. However, it is also possible to apply the e-mail server 7 to voice mail or video mail in which voice and image messages are transmitted by designating the telephone number or the e-mail address of the other party.

Besides, it is possible to construct this system suitable to a large-capacity NNI interface by using an SS7 interface (a common signaling line) for a connection between the system control port to the circuit switching network.

As set forth hereinabove, according to the present invention, it is possible to provide an integrated messaging system, in which a user can store and reproduce multimedia messages on a PC through the Internet, with not a complex structure but a simple one. Also in the structure, the multimedia messages are converted into e-mail attachment-file forms, and integrated into an e-mail server to be stored. Therefore the multimedia messages can be stored in one place, and thus managed easily.

In the integrated messaging system according to the present invention, the media conversion port converts a message into an IP message before the IP store and reproduction port converts the message into a file. Thereby it is possible to change the structure flexibly. Therefore, not only expansion of conversion ports but also high fault tolerance and high availability can be realized.

Besides, in the integrated messaging system according to the present invention, a message is converted into an IP message and an inexpensive IP network is used in transit. Therefore it is possible to relay between a circuit switching network(s) and a voice storing port(s) at a low cost.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An integrated messaging system for storing and reproducing a message from a subscriber comprising:
a circuit switching network;
a media conversion port which receives the message from the subscriber through the circuit switching network and packetizes the message;
a conversion port which converts the packetized message into a storing form; and
a storing port which stores the message converted into the storing form.

2. An integrated messaging system for storing and reproducing a message from a subscriber comprising:
a circuit switching network;
a packet switching network;
a media conversion port which receives the message from the subscriber through the circuit switching network and packetizes the message;
a conversion port which converts the packetized message from the media conversion port and the packet switching network into a storing form; and
a storing port which stores the message converted into the storing form.

3. An integrated messaging system for storing and reproducing a message from a subscriber comprising:
a circuit switching network;
a packet switching network;
a media conversion port which receives the message from the subscriber through the circuit switching network and packetizes the message;
a conversion port which converts the packetized message from the media conversion port and the packet switching network into an e-mail attachment-file form; and
a storing port which is an e-mail server that stores the message converted into the e-mail attachment-file form.

4. An integrated messaging system for storing and reproducing a message from a subscriber who reproduces the message stored in the store port on a PC through the Internet, comprising:
a circuit switching network;
a packet switching network;
a media conversion port which receives the message from the subscriber through the circuit switching network and packetizes the message;
a conversion port which converts the packetized message from the media conversion port and the packet switching network into an e-mail attachment-file form; and
a storing port which is an e-mail server that stores the message converted into the e-mail attachment-file form, and connected to the Internet.

5. The integrated messaging system as claimed in claim 1, wherein the message is a multimedia message at least one selected form voice, a text data, and a moving picture.

6. The integrated messaging system as claimed in claim 2, wherein the message is a multimedia message at least one selected form voice, a text data, and a moving picture.

7. The integrated messaging system as claimed in claim 3, wherein the message is a multimedia message at least one selected form voice, a text data, and a moving picture.

8. The integrated messaging system as claimed in claim 4, wherein the message is a multimedia message at least one selected form voice, a text data, and a moving picture.

9. The integrated messaging system as claimed in claim 1, wherein the message is for a telephone answering machine, which is stored in the case where the called subscriber does not answer a phone.

10. The integrated messaging system as claimed in claim 2, wherein the message is for a telephone answering machine, which is stored in the case where the called subscriber does not answer a phone.

11. The integrated messaging system as claimed in claim 3, wherein the message is for a telephone answering machine, which is stored in the case where the called subscriber does not answer a phone.

12. The integrated messaging system as claimed in claim 4, wherein the message is for a telephone answering machine, which is stored in the case where the called subscriber does not answer a phone.

13. The integrated messaging system as claimed in claim 3, comprising a data base which relates the subscriber's telephone number to the subscriber's e-mail address and stores the telephone number and the e-mail address.

14. The integrated messaging system as claimed in claim 4, comprising a data base which relates the subscriber's telephone number to the subscriber's e-mail address and stores the telephone number and the e-mail address.

15. The integrated messaging system as claimed in claim 1, comprising a data base which relates the subscriber's telephone number to the subscriber's e-mail address and stores the telephone number and the e-mail address, wherein the message is a multimedia message at least one selected form voice, a text data, and a moving picture.

16. The integrated messaging system as claimed in claim 2, comprising a data base which relates the subscriber's telephone number to the subscriber's e-mail address and stores the telephone number and the e-mail address, wherein the message is a multimedia message at least one selected form voice, a text data, and a moving picture.

17. The integrated messaging system as claimed in claim 3, comprising a data base which relates the subscriber's telephone number to the subscriber's e-mail address and stores the telephone number and the e-mail address, wherein the message is a multimedia message at least one selected form voice, a text data, and a moving picture.

18. The integrated messaging system as claimed in claim 4, comprising a data base which relates the subscriber's telephone number to the subscriber's e-mail address and stores the telephone number and the e-mail address, wherein the message is a multimedia message at least one selected form voice, a text data, and a moving picture.

19. The integrated messaging system as claimed in claim 1, comprising a data base which relates the subscriber's telephone number to the subscriber's e-mail address and stores the telephone number and the e-mail address, wherein the message is for a telephone answering machine, which is stored in the case where the called subscriber does not answer a phone.

20. The integrated messaging system as claimed in claim 2, comprising a data base which relates the subscriber's telephone number to the subscriber's e-mail address and stores the telephone number and the e-mail address, wherein the message is for a telephone answering machine, which is stored in the case where the called subscriber does not answer a phone.

21. The integrated messaging system as claimed in claim 3, comprising a data base which relates the subscriber's telephone number to the subscriber's e-mail address and stores the telephone number and the e-mail address, wherein the message is for a telephone answering machine, which is stored in the case where the called subscriber does not answer a phone.

22. The integrated messaging system as claimed in claim 4, comprising a data base which relates the subscriber's telephone number to the subscriber's e-mail address and stores the telephone number and the e-mail address, wherein the message is for a telephone answering machine, which is stored in the case where the called subscriber does not answer a phone.

23. The integrated messaging system as claimed in claim 3, comprising:
a data base which relates the subscriber's telephone number to the subscriber's e-mail address and stores the telephone number and the e-mail address; and
a system control port which controls each port in the system and is connected to the circuit switching network by a common channel line, wherein the media conversion port is connected to the circuit switching network by NNI interface.

24. The integrated messaging system as claimed in claim 4, comprising:
a data base which relates the subscriber's telephone number to the subscriber's e-mail address and stores the telephone number and the e-mail address; and
a system control port which controls each port in the system and is connected to the circuit switching network by a common channel line, wherein the media conversion port is connected to the circuit switching network by NNI interface.

25. The integrated messaging system as claimed in claim 1, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is a multimedia message at least one selected form voice, a text data, and a moving picture; and
the media conversion port is connected to the circuit switching network by NNI interface.

26. The integrated messaging system as claimed in claim 2, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is a multimedia message at least one selected form voice, a text data, and a moving picture; and
the media conversion port is connected to the circuit switching network by NNI interface.

27. The integrated messaging system as claimed in claim 3, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is a multimedia message at least one selected form voice, a text data, and a moving picture; and
the media conversion port is connected to the circuit switching network by NNI interface.

28. The integrated messaging system as claimed in claim 4, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is a multimedia message at least one selected form voice, a text data, and a moving picture; and
the media conversion port is connected to the circuit switching network by NNI interface.

29. The integrated messaging system as claimed in claim 1, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is for a telephone answering machine, which is stored in the case where the called subscriber does not answer a phone; and
the media conversion port is connected to the circuit switching network by NNI interface.

30. The integrated messaging system as claimed in claim 2, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is for a telephone answering machine, which is stored in the case where the called subscriber does not answer a phone; and
the media conversion port is connected to the circuit switching network by NNI interface.

31. The integrated messaging system as claimed in claim 3, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is for a telephone answering machine, which is stored in the case where the called subscriber does not answer a phone; and
the media conversion port is connected to the circuit switching network by NNI interface.

32. The integrated messaging system as claimed in claim 4, comprising:
a data base which relates the subscriber's telephone number to the subscriber's e-mail address and stores the telephone number and the e-mail address; and
a system control port which controls each port in the system and is connected to the circuit switching network by a common channel line, wherein:
the message is for a telephone answering machine, which is stored in the case where the called subscriber does not answer a phone; and
the media conversion port is connected to the circuit switching network by NNI interface.
